(19) United States
(12) Patent Application Publication
(10) Pub. No.: US 2016/0191617 A1
(43) Pub. Date: Jun. 30, 2016

(54) RELOCATING AN EMBEDDED CLOUD FOR FAST CONFIGURATION OF A CLOUD COMPUTING ENVIRONMENT

(71) Applicant: International Business Machines Corporation, Armonk, NY (US)

(72) Inventors: Gregory R. Hintermeister, Rochester, MN (US); David Niedergeses, Rochester, MN (US)

(21) Appl. No.: 14/586,078

(22) Filed: Dec. 30, 2014

Related U.S. Application Data
(63) Continuation of application No. 14/585,475, filed on Dec. 30, 2014.

(51) Int. Cl. H04L 29/08; H04L 12/24

(52) U.S. Cl. CPC H04L 67/1012; H04L 41/0806; H04L 41/0886

(57) ABSTRACT

An apparatus and method expedite configuration and deployment of a scalable cloud computing environment. An environment configuration mechanism (ECM) in a cloud manager provides a number of pre-configured virtual servers as embedded cloud environments. The embedded clouds can be quickly utilized by a system administrator with minimal or no configuration to deploy cloud workloads. The embedded clouds use similarly embedded controllers and hosts. As these embedded clouds begin to use additional resources the ECM dynamically relocates embedded cloud elements from the embedded cloud to a more permanent location on dedicated hardware as attached controllers and hosts.

### BACKGROUND

1. Technical Field

This invention generally relates to cloud computer systems, and more specifically relates to expediting configuration and deployment of a cloud computing environment by relocating a pre-configured, embedded cloud.

2. Background Art

Cloud computing is a common expression for distributed computing over a network and can also be used with reference to network-based services such as Infrastructure as a Service (IaaS). IaaS is a cloud based service that provides physical processing resources to run virtual machines (VM) as a guest for different customers. The virtual machine may host a user application or a server.

Cloud computing environments simplify the deployment and management of network resources such as virtual servers. Cloud computing environments may include a cloud manager that allows a system administrator to manage multiple clouds. Each cloud may include multiple physical servers, each with a hypervisor that provides virtualization of the computing resources. A cloud controller performs cloud management of host servers that run cloud workloads. The cloud computing environment provides efficient and flexible computer resources once it is configured and provisioned with hardware resources. However, setting up all of the resources for a cloud and configuring the cloud is typically very labor-intensive. Further, system administrators often desire to set up test environments and try new configurations before launching the environment full scale. Often these test environments are “throw-away” and the system administrators must start the labor intensive task of configuring a new cloud from “scratch”. For these and other reasons accelerating the configuration process of a cloud is particularly advantageous.

### BRIEF SUMMARY

An apparatus and method expedite configuration and deployment of a scalable cloud computing environment. An environment configuration mechanism (ECM) in a cloud manager provides a number of pre-configured virtual servers as embedded cloud environments. The embedded clouds can be quickly utilized by a system administrator with little or no configuration to deploy cloud workloads. The embedded clouds use similarly embedded controllers and hosts. As these embedded clouds begin to use additional resources the ECM dynamically relocates embedded cloud elements from the embedded cloud to a more permanent location on dedicated hardware as attached controllers and hosts.

The foregoing and other features and advantages of the invention will be apparent from the following more particular description of preferred embodiments of the invention, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a cloud computing node;

FIG. 2 is a block diagram of a cloud computing environment;

FIG. 3 is a block diagram of abstraction model layers;

FIG. 4 is a block diagram of a cloud manager that manages multiple clouds according to the prior art;

FIG. 5 is a block diagram that illustrates an example of a cloud manager with an environment configuration mechanism that provides a pre-configured embedded cloud as described herein;

FIG. 6 is a block diagram that illustrates the relocation of an embedded cloud by the environment configuration mechanism as described herein;

FIG. 7 is a flow diagram of a method for an environment configuration mechanism;

FIG. 8 is a flow diagram of an example method for step 710 in FIG. 7; and

FIG. 9 is a flow diagram of an example method for step 730 in FIG. 7.

### DETAILED DESCRIPTION

The claims and disclosure herein expedite configuration and deployment of a cloud computing environment. An environment configuration mechanism (ECM) provides a number of pre-configured virtual servers as embedded cloud environments. The embedded clouds can be quickly utilized by a system administrator with little or no configuration to deploy cloud workloads. The embedded clouds use similarly embedded controllers and hosts. As these embedded clouds begin to use additional resources the ECM dynamically relocates the workload from the embedded cloud to a more permanent hardware with attached controllers and hosts.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

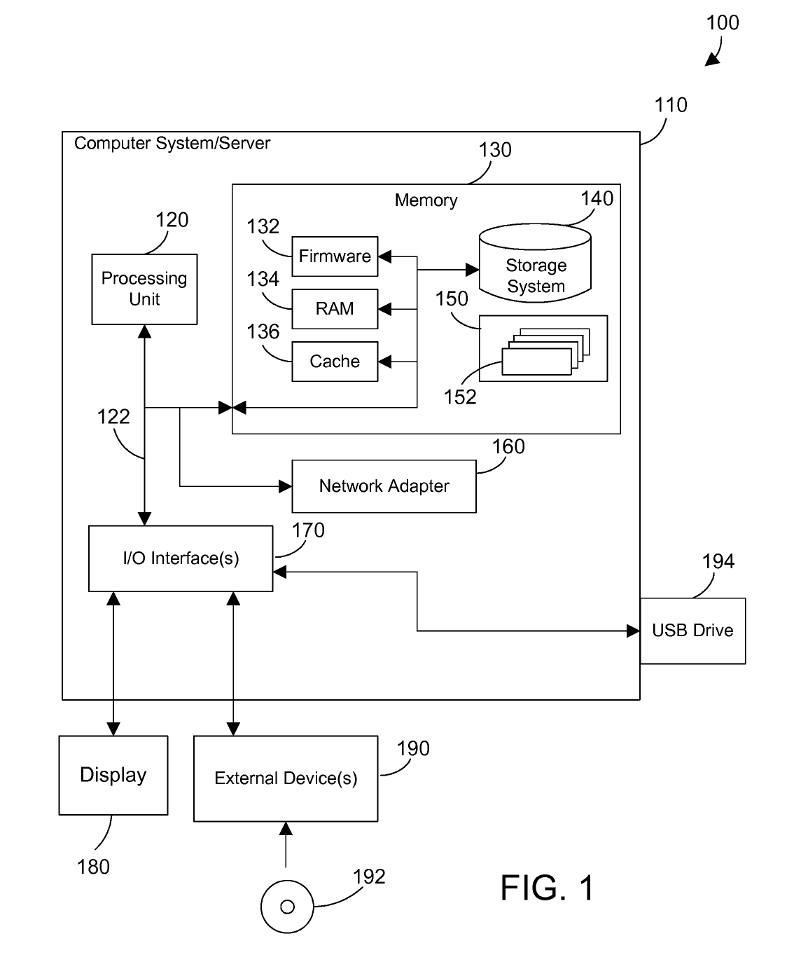

Referring now to FIG. 1, a block diagram of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system/server 110, which is operational with numerous other general purpose or special purpose computing system environments or configurations. Examples of well-known computing systems, environments, and/or configurations that may be suitable for use with computer system/server 110 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 110 may be described in the general context of computer system executable instructions, such as program modules, being executed by a computer system. Generally, program modules may include routines, programs, objects, components, logic, data structures, and so on that perform particular tasks or implement particular abstract data types. Computer system/server 110 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 110 in cloud computing node 100 is shown in the form of a general-purpose computing device. The components of computer system/server 110 may include, but are not limited to, one or more processors or processing units 120, a system memory 130, and a bus 122 that couples various system components including system memory 130 to processing unit 120.

Bus 122 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 110 typically includes a variety of computer system readable media. Such media may be any available media that is accessible by computer system/server 110, and it includes both volatile and non-volatile media, removable and non-removable media. Examples of removable media are shown in FIG. 1 to include a Digital Video Disc (DVD) 192 and a USB drive 194.

System memory 130 can include computer system readable media in the form of volatile or non-volatile memory, such as firmware 132. Firmware 132 provides an interface to the hardware of computer system/server 110. System memory 130 can also include computer system readable media in the form of volatile memory, such as random access memory (RAM) 134 and/or cache memory 136. Computer system/server 110 may further include other removable/non-removable, volatile/non-volatile computer system storage media. By way of example only, storage system 140 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 122 by one or more data media interfaces. As will be further depicted and described below, memory 130 may include at least one program product having a set (e.g., at least one) of program modules that are configured to carry out the functions described in more detail below.

Program/utility 150, having a set (at least one) of program modules 152, may be stored in memory 130 by way of example, and not limitation, as well as an operating system, one or more application programs, other program modules, and program data. Each of the operating system, one or more application programs, other program modules, and program data or some combination thereof, may include an implementation of a networking environment. Program modules 152 generally carry out the functions and/or methodologies of embodiments of the invention as described herein.

Computer system/server 110 may also communicate with one or more external devices 190 such as a keyboard, a pointing device, a display 180, a disk drive, etc.; one or more devices that enable a user to interact with computer system/server 110; and/or any devices (e.g., network card, modem, etc.) that enable computer system/server 110 to communicate with one or more other computing devices. One suitable example of an external device 190 is a DVD drive which can read a DVD 192 as shown in FIG. 1. Such communication can occur via Input/Output (I/O) interfaces 170. Still yet, computer system/server 110 can communicate with one or more networks such as a local area network (LAN), a general wide area network (WAN), and/or a public network (e.g., the Internet) via network adapter 160. As depicted, network adapter 160 communicates with the other components of computer system/server 110 via bus 122. It should be understood that although not shown, other hardware and/or software components could be used in conjunction with computer system/server 110. Examples, include, but are not limited to: microcode, device drivers, redundant processing units, external disk drive arrays, Redundant Array of Independent Disk (RAID) systems, tape drives, data archival storage systems, etc.

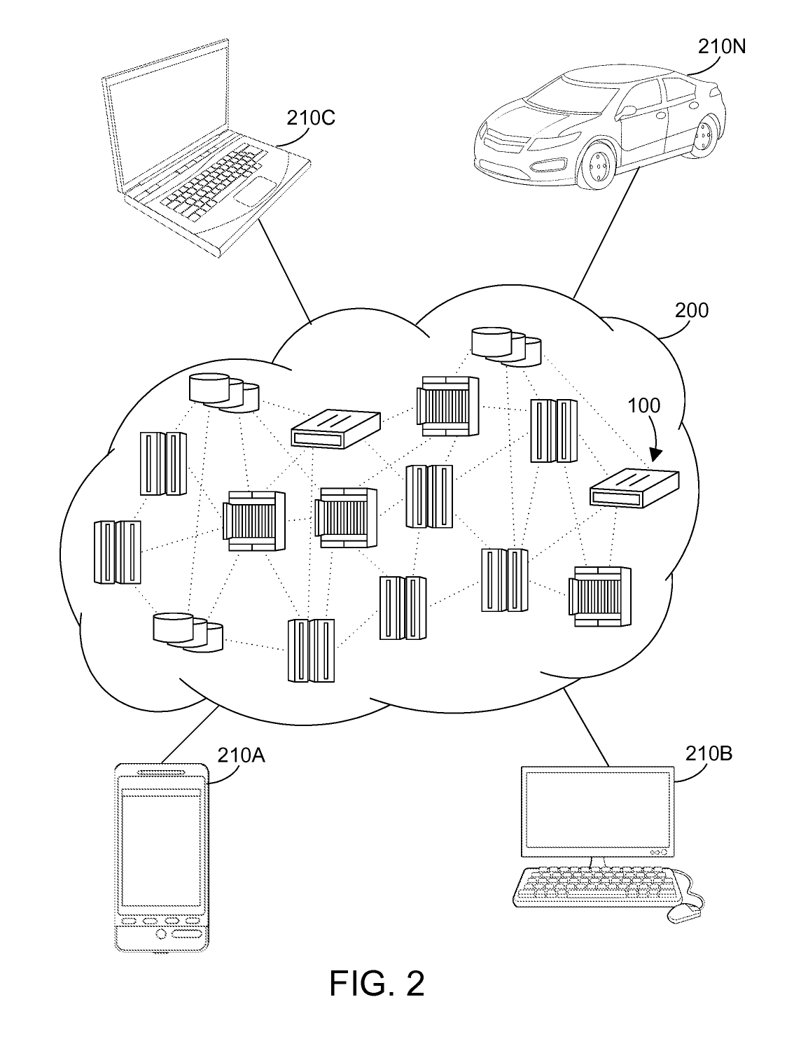

Referring now to FIG. 2, illustrative cloud computing environment 200 is depicted. As shown, cloud computing environment 200 comprises one or more cloud computing nodes 100 with which local computing devices used by cloud consumers, such as, for example, personal digital assistant (PDA) or cellular telephone 210A, desktop computer 210B, laptop computer 210C, and/or automobile computer system 210N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 200 to offer infrastructure, platforms and/or software as services for which a cloud consumer does not need to maintain resources on a local computing device. It is understood that the types of computing devices 210A-N shown in FIG. 2 are intended to be illustrative only and that computing nodes 100 and cloud computing environment 200 can communicate with any type of computerized device over any type of network and/or network addressable connection (e.g., using a web browser).

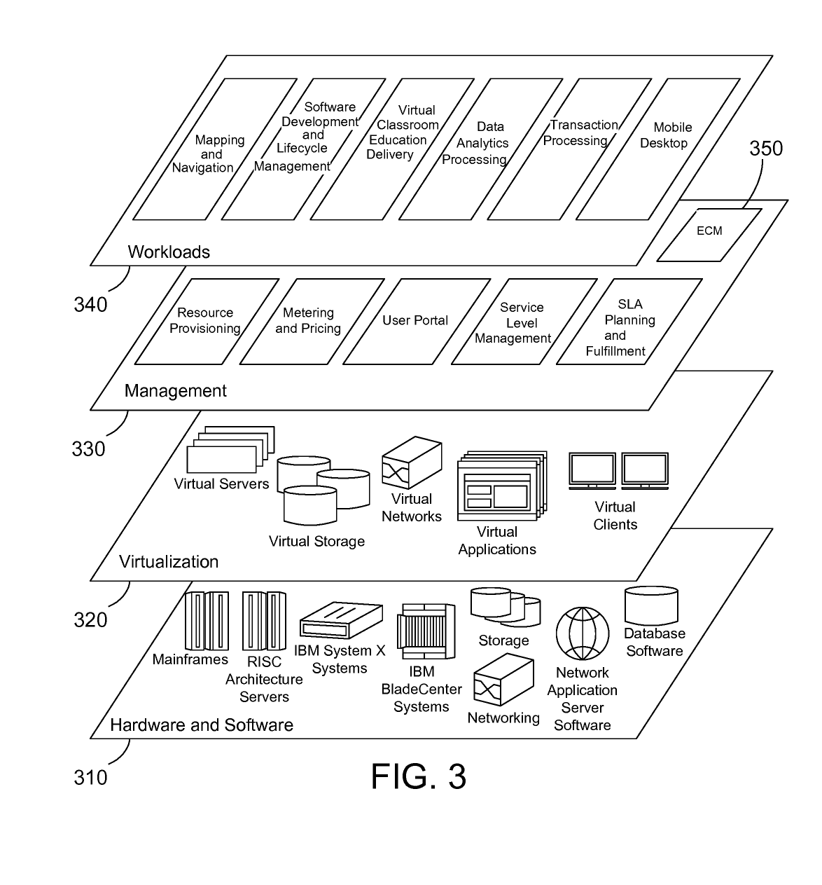

Referring now to FIG. 3, a set of functional abstraction layers provided by cloud computing environment 200 in FIG. 2 is shown. It should be understood in advance that the components, layers, and functions shown in FIG. 3 are intended to be illustrative only and the disclosure and claims are not limited thereto. As depicted, the following layers and corresponding functions are provided.

Hardware and software layer 310 includes hardware and software components. Examples of hardware components include mainframes, in one example IBM System z systems; RISC (Reduced Instruction Set Computer) architecture based servers, in one example IBM System p systems; IBM System x systems; IBM BladeCenter systems; storage devices; networks and networking components. Examples of software components include network application server software, in one example IBM WebSphere® application server software; and database software, in one example IBM DB2® database software. IBM, System z, System p, System x, BladeCenter, WebSphere, and DB2 are trademarks of International Business Machines Corporation registered in many jurisdictions worldwide.

Virtualization layer 320 provides an abstraction layer from which the following examples of virtual entities may be provided: virtual servers; virtual storage; virtual networks, including virtual private networks; virtual applications and operating systems; and virtual clients.

In one example, management layer 330 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. The management layer further includes an environment configuration mechanism (ECM) 350 as described herein. While the ECM 350 is shown in FIG. 3 to reside in the management layer 330, ECM 350 actually may span other levels shown in FIG. 3 as needed. The ECM may be incorporated into a cloud manager known in the prior art to achieve enhanced cloud management with the additional functions described herein.

Workloads layer 340 provides examples of functionality for which the cloud computing environment may be utilized. Examples of workloads and functions which may be provided from this layer include: mapping and navigation; software development and lifecycle management; virtual classroom education delivery; data analytics processing; transaction processing and mobile desktop.

As will be appreciated by one skilled in the art, aspects of this disclosure may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As introduced above, the disclosure herein provides an apparatus and method to expedite configuration and deployment of a cloud computing environment. The environment configuration mechanism (ECM) pre-deploys on a physical server a number of pre-configured virtual servers as embedded cloud environments or more simply referred herein as embedded clouds. These embedded clouds can be quickly utilized by a system administrator with little or no configuration to deploy cloud workloads because they are already configured with embedded controllers and hosts. These embedded clouds are configured with a minimal set of resources so multiple clouds can be preconfigured on a physical server. When these embedded clouds become loaded and begin to use significant cloud resources the ECM dynamically relocates the workload from the embedded cloud to more permanent hardware with attached controllers and hosts. The ECM may monitor the loading of the cloud elements in the cloud and when the loading exceeds a threshold relocate the embedded cloud elements to the permanent hardware. The relocation can be fully automatic or may be with the assistance of the system administrator. This allows the user to quickly utilize the preconfigured cloud without significant time to configure the cloud.

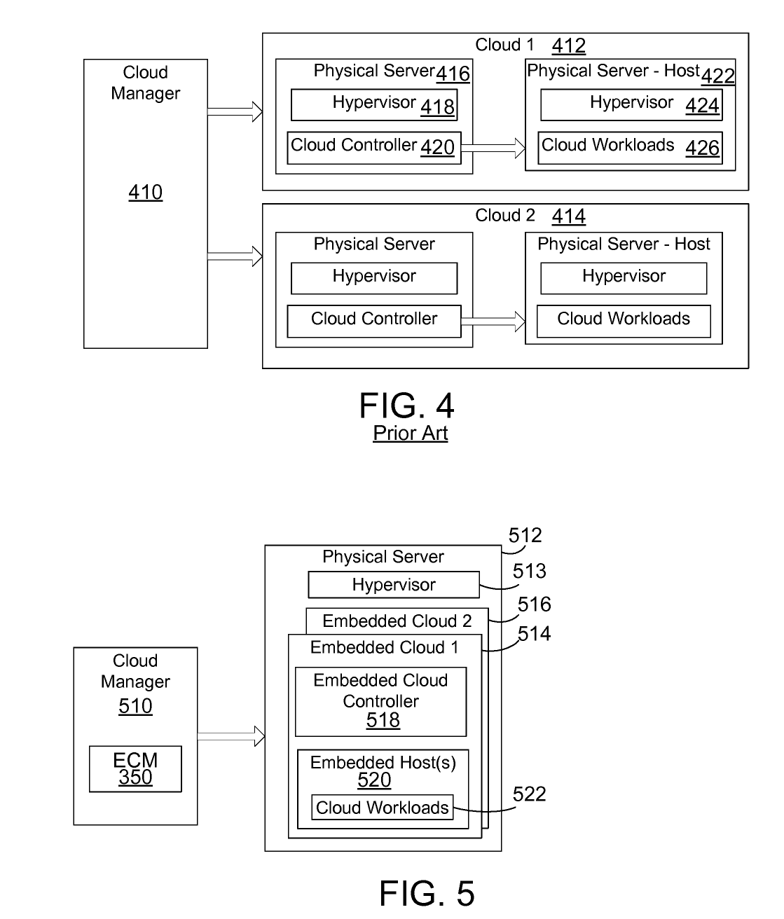

Referring now to FIG. 4, a block diagram illustrates a multiple cloud system with a cloud manager 410 according to the prior art. The cloud manager 410 manages a number of individual clouds. In this example, the cloud manager 410 manages Cloud 1 412 and Cloud 2 414. A cloud may have any number of physical servers associated with it. In the illustrated example, Cloud 1 has a physical server 416 with a hypervisor 418. The physical server 416 has a cloud controller 420 that controls the cloud, including a second physical server 422. The second physical server 422 also has a hypervisor 424. The second physical server acts as a host to cloud workloads 426.

Referring now to FIG. 5, a block diagram presents an example of an environment configuration mechanism (ECM) 350 that expedites configuration and deployment of a cloud computing environment. As introduced above, the ECM may be part of the management layer 330 of the cloud system in FIG. 3. In this example, the ECM is incorporated into a cloud manager 510. The cloud manager 510 manages any number of embedded clouds on one or more physical servers as introduced above with reference to FIG. 4. In this example, cloud manager 510 manages multiple clouds on a physical server 512 that has a hypervisor 513. The cloud manager 510 in conjunction with the ECM 350 manages Embedded Cloud 1 514 and Embedded Cloud 2 516 on the physical server 512 as described further below. The physical server 512 may be one of the systems shown in the hardware and software level 310 in FIG. 3.

Again referring to FIG. 5, the ECM 350 predeploys a number of embedded clouds that will be made available for use by a system administrator. In the example illustrated in FIG. 5, the ECM is shown having predeployed two embedded clouds, Embedded Cloud 1 514 and Embedded Cloud 2 516. The predeployed embedded clouds 514, 516 have a predetermined set of resources for the cloud elements. In this example, the cloud elements of the embedded cloud 514 include an embedded cloud controller 518 and embedded host(s) 520. The embedded cloud controller 518 is a virtual machine that provides cloud management functions such as deploying virtual machines. The embedded host(s) 520 include a virtual machine acting as physical host that can be selected by a user for deployment of cloud workloads 522. Thus the embedded cloud controller 518 and the embedded hosts 520 comprise a virtual cloud that has been allocated a predetermined set of physical server resources. The predetermined set of resources could include CPU and memory allocation to run in the embedded cloud. The resource allocations of the preconfigured embedded clouds are limited to a set of minimal resources. As used herein, minimal physical resources means that the embedded clouds are given a limited set of resources on the physical server so multiple clouds can be preconfigured and deployed on the physical server. The physical resources include CPU utilization, memory usage and network bandwidth. The embedded cloud needs enough physical server resources to run initial workloads deployed by the administrator but minimal enough to allow many clouds to be predeployed on the physical server. Later, the ECM can allocate additional resources as needed to the embedded cloud elements in order to keep the embedded cloud functional.

Pre-deployment of the embedded cloud by the ECM may include identifying an available server with available resources and deploying a hypervisor on the identified available server. The ECM deploys an embedded controller as a virtual machine on the available server. An embedded host is also deployed on the virtual server and the embedded host is registered to the embedded controller so that it can be provided as an embedded cloud to a user to deploy workloads. The embedded host may include Kernel-based Virtual Machine (KVM). KVM is open-source software that provides virtualized hardware to multiple virtual machines.

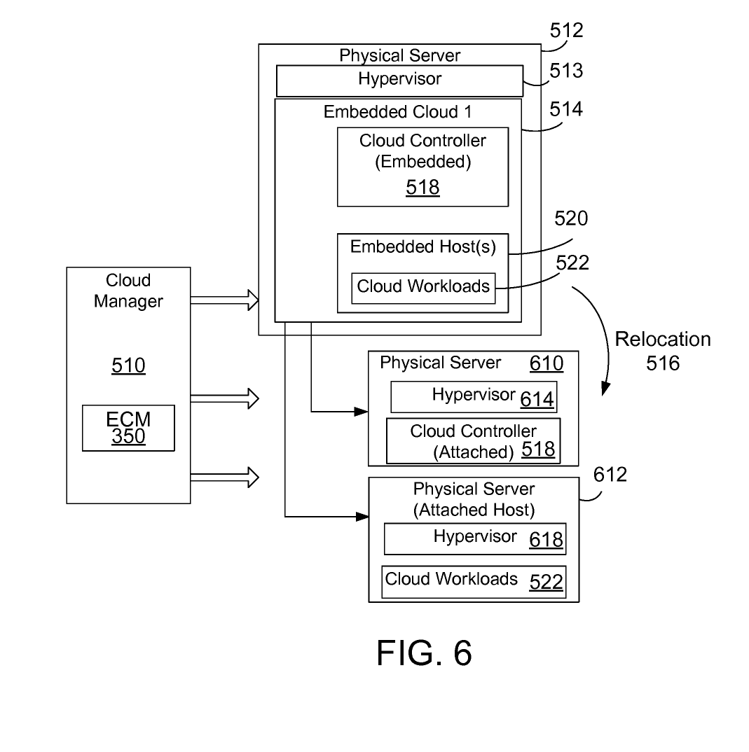

FIG. 6 is a block diagram that illustrates relocation of an embedded cloud. As described with reference to FIG. 5, the ECM 350 predeploys a number of embedded clouds that will be made available for use by a system administrator. In FIG. 6 the embedded cloud 1 514 was pre-deployed on the physical server 512 as described above. The embedded cloud 1 514 includes embedded cloud elements. In this example, the embedded cloud elements include an embedded cloud controller 518 and embedded host(s) 520. The ECM 350 monitors the loading of the embedded cloud elements on the physical resources of the physical server 512. When the loading on a physical server 512 from the embedded cloud elements exceeds a preset threshold, the ECM initiates relocation 516 of the embedded cloud elements. In this example, the ECM relocates the cloud controller 518 to a physical server 610 and relocates the cloud workloads 522 from the embedded host 520 to a physical server 612. The physical server 610 has a hypervisor 614 and the physical server 612 has a hypervisor 618.

As introduced above, the ECM monitors the loading of the embedded cloud elements to relocate the embedded cloud elements when the loading of a threshold parameter exceeds a preset threshold. One example of a thresholds parameter could be central processing unit (CPU) utilization. An example threshold would be 80% CPU utilization for a given time period such as 2 minutes. Similarly, another threshold parameter could be the number of allocated CPUs greater than or equal to some percentage of the total number of CPUs in the system. If the CPU threshold is exceeded, then the cloud manager would start preparing available hardware and connecting it to the cloud controller and start initiating live relocation of the running workloads. The ECM could relocate all workloads, or it could relocate some subset of the workloads to ensure all hosts can handle the workloads without exceeding the thresholds. In these examples the loading was determined for an individual cloud element. Alternatively the resource loading could be determined for the entire cloud and in response to loading exceeding a threshold one or more cloud elements could be chosen to be relocated.

Again referring to FIG. 6, the ECM relocates the embedded cloud elements when the loading on the cloud resources exceeds a preset threshold as described above. The process of relocation of the embedded cloud elements may differ depending on the type of the embedded cloud element. If the loading is above a threshold as described above then the ECM determines if the cloud element is a host or a controller. If the element is a host then the ECM deploys a hypervisor on a new physical server to create a new host, adds the new host into the cloud controller, and relocates the workloads of the embedded host into the new host. The ECM may then remove the embedded hosts from the original location. However, if the cloud element is a controller, then the ECM deploys a hypervisor on a new physical server and relocates the controller to the new physical server. The cloud controller on the new physical server can thus utilize available server resources of the new physical server.

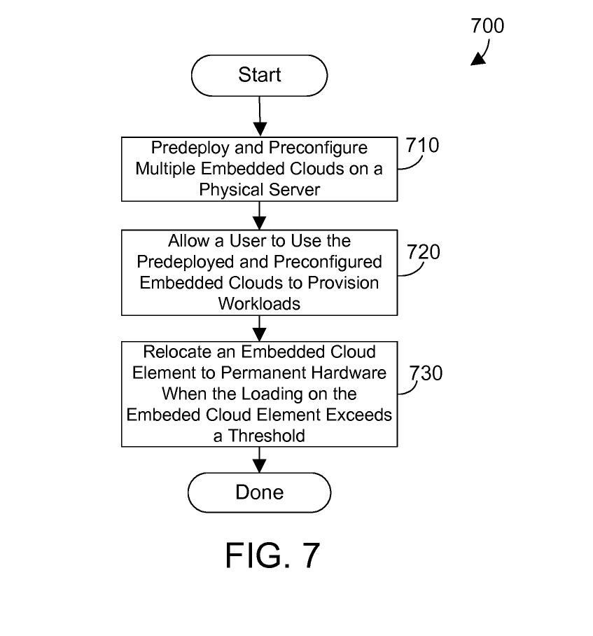

FIG. 7 illustrates a flow diagram of a method 700 for expediting configuration and deployment of a scalable cloud computing environment. The method 700 is presented as a series of steps performed by a computer software program such as the environment configuration mechanism 350 described above. First, predeploy and preconfigure multiple embedded clouds on a physical server (step 710). Allow a user to use the predeployed and preconfigured embedded cloud to provision workloads (step 720). Relocate an embedded cloud element to permanent physical hardware when loading on the embedded cloud element exceeds a threshold (Step 730). The method is then done.

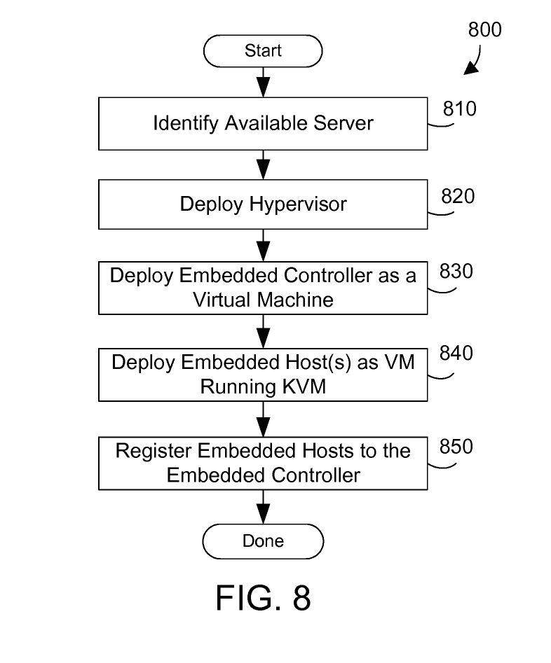

Referring now to FIG. 8, a flow diagram shows method 800 that is an exemplary method for performing step 710 in method 700. The method 800 is presented as a series of steps performed by a computer software program described above as the environment configuration mechanism 350. First, identify an available server (step 810). Deploy a hypervisor on the identified available server (step 820). Deploy an embedded controller as a virtual machine (step 830). Deploy an embedded host as a virtual machine running kernel virtual machine (KVM) (step 840). Register the embedded hosts to the embedded controller (step 850). The method is then done. The embedded cloud is now ready for a user to start deploying workloads.

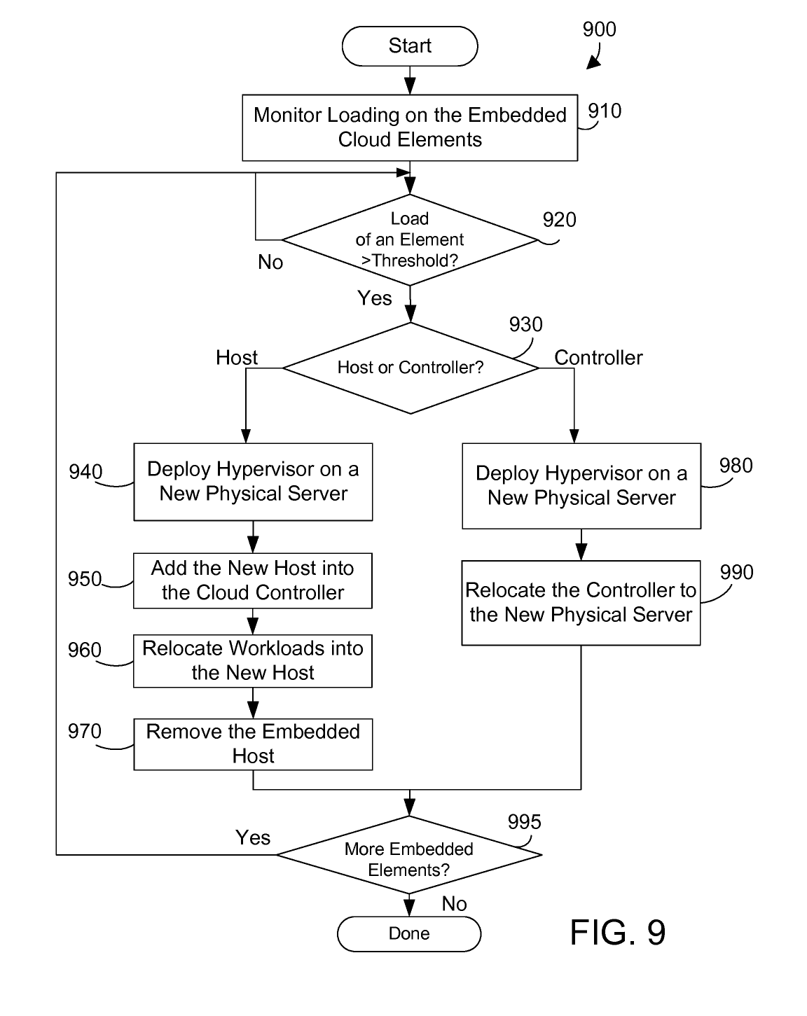

Referring now to FIG. 9, a flow diagram shows method 900 that is an exemplary method for performing step 730 in method 700. The method 900 is presented as a series of steps performed by a computer software program described above as the environment configuration mechanism 350. First, monitor loading on the embedded clouds elements (step 910). Determine if the load of an element is above a threshold (step 920). If the load is not above a threshold (step 920=no) then return to step 920 and continue monitoring the loading. When the loading is above a threshold (step 920=yes) then determine if the element is a host or a controller (step 930). If the element is a host (step 930=host) then deploy a hypervisor on a new physical server for a new host (step 940). Add the new host into the cloud controller (step 950) and relocate the workloads of the embedded host into the new host (step 960). Remove the embedded host (step 970). If the element is a controller (step 930=controller) then deploy a hypervisor on a new physical server (step 980). Relocate the controller to the new physical server to provide additional resources for the controller (step 990). If there are remaining elements (step 995=yes) then return to step 920, else if there are no remaining elements (step 995=no) then the method 900 is done.

The claims and disclosure herein provide an apparatus and method to expedite configuration and deployment of a scalable cloud computing environment. The configuration mechanism provides a number of pre-configured virtual servers as embedded cloud environments that can be quickly utilized by a system administrator with little or no configuration to deploy cloud workloads.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
at least one processor;
a memory coupled to the at least one processor;
an environment configuration mechanism residing in the memory and executed by the at least one processor, wherein the environment configuration mechanism predeploys and preconfigures a plurality of embedded clouds with a plurality of embedded cloud elements on a physical server, and
wherein the environment configuration mechanism allows a user to use an embedded cloud of the plurality of embedded clouds to provision workloads, and relocates an embedded cloud element of the plurality of embedded cloud elements to permanent physical hardware when a resource loading of the embedded cloud element exceeds a threshold.

2. The apparatus of claim 1 wherein the environment configuration mechanism monitors resource loading of the embedded cloud element on the physical server.

3. The apparatus of claim 2 wherein the resource loading of the embedded cloud element comprises CPU utilization over a period of time.

4. The apparatus of claim 2 wherein the resource loading of the embedded cloud element on the physical machine comprises disk utilization and network utilization.

5. The apparatus of claim 1 wherein a user sets the threshold.

6. The apparatus of claim 1 wherein the environment configuration mechanism preconfigures the embedded cloud with a minimal set of cloud resources, where the minimal set of resources includes central processing unit resources and memory resources such that multiple embedded clouds can be predeployed on the physical server.

7. The apparatus of claim 1 wherein the environment configuration mechanism predeploys the plurality of embedded clouds by identifying an available server, deploying a hypervisor on the available server, deploying an embedded controller as a virtual machine, deploying an embedded host and registering the embedded host to the embedded controller.

8. The apparatus of claim 1 wherein the environment configuration mechanism determines the embedded cloud element is a host and relocates the host cloud element by deploying a hypervisor on a new physical server, adding a new host into the cloud controller and relocating workloads into the new host.

9. The apparatus of claim 1 wherein the environment configuration mechanism determines the embedded cloud element is a controller and relocates the controller cloud element by deploying a hypervisor and a new cloud controller on a new physical server and dedicating physical resources of the new physical server to the new cloud controller.
